(19) United States
(12) Patent Application Publication
(10) Pub. No.: US 2014/0270898 A1
(43) Pub. Date: Sep. 18, 2014

(54) Attachments for Spray Bottles

(71) Applicant: Kassara Sukul, Fontana, CA (US)

(72) Inventor: Kassara Sukul, Fontana, CA (US)

(21) Appl. No.: 14/216,282

(22) Filed: Mar. 17, 2014

Related U.S. Application Data
(60) Provisional application No. 61/791,665, filed on Mar. 15, 2013.

(51) Int. Cl. B05B 1/00

(52) U.S. Cl. CPC B05B 1/00
USPC 401/190

(57) ABSTRACT

An applicator configured for operative engagement with pressurized fluid stream from a spray bottle is provided. The applicator attaches to an engagement component having a passage communicating between a first end configured for engagement with the nozzle of the spray bottle. The applicators can be provided as a kit of different applicators each operatively engageable with the nozzle.

### BACKGROUND OF THE INVENTION

1. Field of the Invention

This application is a U.S. Nonprovisional Patent Application of U.S. Provisional Application Number 61/791,665 filed on Mar. 15, 2013. The present invention relates generally to applicator attachments for spray bottles or other liquid containers. More particularly the invention relates to a device and kit of components configured for removable engagement of applicator attachments to a spray nozzle of a bottle or other suitable liquid container.

2. Prior Art

Conventional spray bottles comprise a liquid container having a removably engageable spray nozzle allowing the user to dispense fluid from the container and out of a discharge end of the nozzle, in a fluid stream, spray, or mist. The spray nozzle typically employs a threaded engagement to the fluid container and comprises a lever-actuated pump (also referred to as a trigger sprayer) which is squeezed by the user for pumping the fluid from the container into the nozzle via a down tube, through the nozzle, and to the discharge end for dispensing the fluid as such.

Spray bottles are commonly used for conveniently dispensing various types of liquid cleaning solutions, liquid waxes, polishing solutions, and the like, as they can be operated with one hand while leaving the other hand free for other tasks such as scrubbing, polishing, or additional cleaning. In addition, it is known in the art that spray bottles may employ applicator components engaged to the nozzles at or near the discharge end, thereby allowing the user to dispense fluid while simultaneously employing the applicator component, be it a sponge, scrubber, polisher or the like.

Unfortunately, current products available include spray nozzles and applicator components formed as unitary structures. Thus, a user desiring to employ various applicator types within a common fluid container must unthread and rethread the desired nozzle/applicator component from the fluid container for each intended use. Reasons for replacing the applicator may be for changing to a different type (i.e. scrubber to polisher), or simply when an applicator becomes worn and must be replaced. As could be imagined, users with limited dexterity due to arthritis, old age, or other ailment, may find the task of unthreading and rethreaded the various nozzles to be quite difficult, if not painful and possible impossible.

As such, there is a continuing and unmet need for a device and especially including a kit of components, which allows a user to removably engage an applicator attachment to any spray nozzle, without the need to remove the nozzle from the fluid container nor to make any mechanical changes to the existing nozzle. Such a device should provide a means for sealed and removable engagement which is easy to engage and disengage and which does not damage the existing nozzle component. Such a device should allow a user to simultaneously dispense a liquid while employing an applicator, or a scrubber, or a cleaning component or a polishing head, or another desired task. Such a device be employable individually or as a member of a a kit of components which allows a user to select the desired applicator attachment from the kit of components comprising a plurality of different types of removable applicator attachments.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The device herein disclosed and described provides a solution to the shortcomings in prior art and achieves the above noted goals through the provision of a removably engageable spray nozzle applicator device. In accordance with a first preferred mode, the device includes a removably engageable applicator and a spray nozzle. The spray nozzle comprises a nozzle body employing means for removable engagement to a conventional spray bottle or other liquid container, having a lever activated pump in fluid communication with a down tube and a discharge end of the nozzle, and means for removable engagement with the applicator.

It is intended that the nozzle can be engaged to a wide variety of conventional spray bottles, employing threaded or other engagement means for their engaged nozzles. However other modes are envisioned wherein the nozzle and bottle could be provided in a permanent engagement as a unitary structure, but allowing multiple head changes, and is anticipated within this disclosure.

The removably engageable applicator and spray nozzle preferably employ mating fasteners for providing the means for removable engagement of the applicator to the nozzle. Preferred mating fastener types can included, however without implying limitations, respective male and female threaded fasteners, snap fasteners, frictional engagement fasteners, or other fastener type suitable for the intended purpose.

In another mode of the invention, the device includes the removably engageable applicator and an applicator engagement component configured with means for removable engagement with the applicator, such as the mating fasteners noted previously. In this mode the applicator engagement component is further adapted for removable engagement to a conventional spray nozzle, at or near the discharge end thereof.

Due to the variety of conventional spray nozzle shapes and geometries known in the art, it is preferred that the means for removable engagement of the applicator engagement component to the conventional spray nozzle provides a universal means for engagement. Currently, a particularly preferred means for such engagement is provided by an elastic and highly adjustable removable component wherein stretching of the elastic material generates a compressive bias and a friction fit provided by contraction of the stretched elastic tubing, or other means suitable for the intended purpose. The elastic engagement component may be of a single diameter, or a plurality of ever widening diameters to accommodate a biased frictional engagement against a plurality of different sized spray nozzle circumferences. One or more of the wider circumferences on a multiple sized elastic end may be removed to allow better insertion to narrower diameters further in, if needed. Thus, the user can engage the applicator engagement component to any conventional spray nozzle and employ the utility of the removable engagement of the applicator as needed.

In yet another mode of the invention, a kit mode is providable to the user comprising a kit including one or any suitable combination of, one or a plurality of different removably engageable applicators, one or a plurality of spray nozzles, and one or a plurality of applicator engagement components.

It is briefly noted that upon a reading this disclosure, those skilled in the art will recognize various means for carrying out these intended features of the invention. As such it is to be understood that other methods, applications and systems employing software adapted to the task may be configured to carry out these features and are therefor considered to be within the scope and intent of the present invention, and are anticipated.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed nozzle engagement device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

It is an object of the invention to provide the user with a means for engaging the nozzle and dispensing liquid from a bottle or other container while employing an applicator, for scrubbing, cleaning, buffing, or other task, at the same time.

It is an object of the invention to provide a device which combines a spray nozzle engagement component and applicator, which eliminates the need for the user to purchase both items separately.

Other objects, features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. In the drawings:

FIG. 1 shows a view of a preferred mode of the invention comprising a removable engageable applicator and a spray nozzle, prior to the engagement of the applicator to the nozzle.

FIG. 2 shows spray nozzle and applicator of FIG. 1 in an engaged, as-used mode.

FIG. 3 depicts a side view of another mode of the applicator.

FIG. 4 shows a front view of the applicator of FIG. 3.

FIG. 5 shows a side view of another mode of the applicator.

FIG. 6 shows a top view of the applicator of FIG. 5.

FIG. 7 shows a view of another mode of the invention comprising a removably engageable applicator and an applicator engagement component for engagement to an conventional spray nozzle.

FIG. 7A shows a detailed view of the elastic means of compressive biased engagement of the applicator engagement component to a nozzle.

FIG. 7B shows a sliced through FIG. 7a wherein the applicator engagement component has a single interior size.

FIG. 7C shows the component of FIG. 7A wherein the engagement component as a first axial diameter and a wider axial diameter to accommodate larger circumference nozzles.

FIG. 7D shows another favored mode of the component of FIG. 7A which has a series of axial passage sized to accommodate wider and narrower engagments. The wider sections can be frangible and removable.

FIG. 8 shows a kit mode of the device.

Other aspects of the present invention shall be more readily understood when considered in conjunction with the accompanying drawings, and the following detailed description, neither of which should be considered limiting.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

Now referring to drawings in FIGS. 1-8, wherein similar components are identified by like reference numerals, there is seen in FIG. 1 and FIG. 2 views of a first preferred mode of the removably engageable spray nozzle applicator device 10 adapted to engage with the pressurized fluid stream from a spray nozzle as well as in FIG. 7.

In accordance with one preferred mode, the device 10 is adapted for engagement to the fluid stream discharge from a projecting nozzle 101 of existing pump nozzles 100 enagaged to cleaning and polishing and other bottles such as shown in FIG. 7, and employing the frictional enagement shown in any of FIGS. 7a-d.

The device 10 has shown and sold as a unitary structur in FIGS. 1-2, includes a removably engageable applicator 28 and a spray nozzle 11 comprising a nozzle body 12, means for engagement to a conventional spray bottle or other liquid container (not shown) such as threads 24, a pump lever 14, a pump 18, a down tube 20, and a discharge end 22 of the nozzle.

The pump 18 is in fluid communication with the down tube 20 and discharge end 22 of the nozzle 11, such that activation of the pump 18 via the lever 14 by a squeezing of the lever 14 in the hand of a users will communicate fluid from inside an engaged bottle (not shown) through the down tube 20 and out the discharge end 22 of nozzle. It is noted that those skilled in the art may recognize other suitable means for dispensing the fluid, other than the lever activated pump 18, and are anticipated. This can include pressurized containers, hand pumps, and the like. Also while the applicator 28 is shown with bristles, it may also include fabric, sponge, or any other material or formation adapted to the task of applying the contents of the engaged container to a surface.

In the mode of the device having a pump lever 14 and pump 18 and relted components, removably engageable applicator 28 and spray nozzle 11 preferably employ mating fasteners for providing a means for removable engagement of the applicator 28 to the nozzle 11. Particularly preferred mating fasteners shown in FIG. 1 are male 32 and female 26 threaded fasteners. However other mating fastener types additionally providing a suitable means for removable engagement may be employed and are anticipated. For example this can include, however without implying limitations, snap fasteners, frictional engagement fasteners, or other fastener type recognized by those skilled in the art as deemed suitable for the intended purpose.

It is the intent of the current mode of the device 10 that the nozzle 11 can be engaged to conventional spray bottles, employing threaded 24 or other engagement means, however it is noted and anticipated that in other modes the nozzle 11 and a bottle can be in a permanent engagement as a unitary structure. However, in all modes of the device it is intended that the user is provided with a means for dispensing liquid from a bottle or other container and employing an applicator, for scrubbing, cleaning, buffing, or other task, at the same time.

The applicator 28 includes an engagement end herein provided by the male threaded fastener 32 and a utility end currently shown as a plurality of scrubbing bristles 30. Thus the user can dispense liquid from the discharge end 22 of the nozzle 11 while scrubbing using the scrubbing bristles 30 of the removably engageable applicator 28.

It is anticipated that other utility ends types may be employed for different applications. Those skilled in the art will recognized various other suitable utility end types which can be employed with the present invention. Therefor, it is understood that the depictions and descriptions provided herein are merely for the purpose of illustrating the overall intent, however not limiting the scope of the present invention.

With that being said, there is shown in FIG. 3 and FIG. 4, another preferred mode of the applicator 28 providing a sponge end 34. Further, FIG. 5 and FIG. 6 show yet another preferred mode of the applicator 28 comprising a scraper head 40. These modes of the applicator 28 may be employed with the unitary structure device of FIGS. 1-2 or as a device adapted for engagement to existing nozzles 101 shwon in FIG. 7.

In all modes of the applicator 28, there is included an axial passage 36 communicating therethrough providing a passage for communicating the pressurized fluid stream being dispensed from the nozzle 11 through the passage 36 and through a conduit in the applicator engagement component 42, to the applicator 28 and the underlying surface of application, such a vehicle body, kitchen counter, or the like. Further, the passage 36 can be sized and configured to communicate at least some of the dispensing fluid to the surface of the applicator 28 such as the bristles 30, sponge 34, or the like, for wetting purposes of the sponge 34 or bristles 30, to improve the cleaning or scrubbing capabilities of the applicator 28.

The various components of the device disclosed herein can be formed of conventional materials such as plastic, PVC, polypropylene, polyethylene, however can be formed of any material suitable for the purposes set forth in this disclosure.

In another particulary preferred mode of the device 10 shown in FIG. 7, the device 10 is adapted to engage to the nozzle 101 of existing spray nozzles 100 of conventional containers and thus uses much less plastic and the like for formation. In this preferred mode, the device 10 includes a removably engageable applicator 28 which engages with an applicator engagement component 42 having means on an opposite end, for removable engagement with the an existing nozzle 101.

Removable engagement of the applicator 28 is as with the unitary version such as the female threaded fasteners 26 or other cooperatively mating fasteners or as noted previously. In this mode the applicator elastic engagement component 44 is shown in FIG. 7, adapted for removable engagement to a conventional spray nozzle 100 employing the elastic enagement components 44 of FIGS. 7a-d. Such a nozzle elastic engagement component 44 is preferably, however not limited to, an engagement at or near the discharge end 102 thereof.

Due to the variety of conventional spray nozzle shapes, diamaters, and geometries known in the art, it is preferred that the means for removable engagement of the applicator engagement component 42, to a biased firctional engagement to the circumference of a conventional spray nozzle 100, is an elastic material to provide a universal engagement means. A current such means for removable engagement to a nozzle 101 which is adapatable is through the employment of an elastic-enhanced biased frictional engagement component 44 which an interior circumfrence in baised frictional enagement about the circumferenc of an exisiting nozzle 100 which is employed on many conventional bottles. A preferred mode of the elastic engagement component 44 is shown in FIG. 7a, where the interior circumference 37 is adapted to engage an nozzle 101 having a circumfrence equal to or slightly larger than the interior circumfrence 37 of the elastic component 42.

FIG. 7B shows a sliced through a mode of the elastic engagment component 44 of FIG. 7A wherein it has a single interior circumfrence 37 size.

FIG. 7C shows the component of FIG. 7a wheren the elastic enggement component 44 has a first axial diamater of the interior circumfrence 37, and a wider axial diamater of the interior circumfrence 37 to accomadate larger circumferences.

FIG. 7D shows another favored mode of the elastic engagement component 44 of FIG. 7A which has a series of axial passage circumfrence sizes to accomadate wider and narrower engagments on the exterior circumfrence of nozzles 101. The wider sections can be perforated and rendered frangible and removable so as to add multiple sized larger and larger circumfrences which may be removed to allow axial engagement with smaller circumfrence sizes.

As noted, in the current mode, the applicator engagement component 42 includes the engagement component 44 formed of preferably of a flexible resilient material such as rubber, or surgical tubing, or other polymeric tubing, which is adapted for a frictional engagement to the conventional nozzle 100. By employing rubber or other flexible material, the engagement component 44 can easily be stretch and adjusted to thereby frictionally secure over the discharge end 102 of a conventional nozzle 100. Thus, the user can engage the applicator engagement component 42 to the circumfrenece of any conventional spray nozzle and employ the utility of the removable engagement of the applicator 28 as needed.

In a particularly preferred a kit mode of the device 10 shown in FIGS. 1 and 7, a kit 46 is providable to the user and can comprise one or any suitable combination of, one or a plurality of different removably engageable applicators 28, one or a plurality of spray nozzles 11, and one or a plurality of applicator engagement components 42. The kit 46 thereby provides additional utility providing the user with the option of employing the removable applicators 28 with the applicator engagement components 42 on existing trigger spray bottles, and employing the nozzle 11 on any desired bottle.

This invention has other applications, potentially, and one skilled in the art could discover these. The explication of the features of this invention does not limit the claims of this application; other applications developed by those skilled in the art will be included in this invention.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. An applicator apparatus configured for operative engagement with pressuized fluid stream from a spray bottle, comprising:
an engagement component having a passage communicating between a first end and a second end;
said first end having means for removable enagement to a nozzle of a spray bottle;
an applicator having a first side configured to communicate said pressurized fluid stream therethrough; and
mating fasteners for removable engagement of said first side of said applicator to said second end of said enagement component, whereby said pressurized fluid stream is communicated through said applicator to a surface from said spray bottle.

2. The applicator apparatus of claim 1 wherein, said means for removable enagement of said first end to a nozzle of a spray bottle, comprises:
an elastic conduit having an axial passage therethrough;
a first end of said elastic conduit engaged with said first end of said engagement component;
said second end having an interior circumference equal to or smaller than an exterior circumference of said nozzle; and
said interior circumference of said elastic conduit removably engageable to a frictional engagement with said exterior circumfrence of said nozzle.

3. The applicator apparatus of claim 2 additionally comprsing:
said second end of said elastic conduit having an interior circumference having a plurality of segments in a sequence from said second end running toward said first end;
a first segment in said sequence having a first said interior circumference; and
each additional said segment in said sequence having a smaller said interior circumference than an adjacent respective said segment inbetween said additional said segment and said second end, whereby a said nozzle inserted into said interior circumference at said second end, will engage a said interior circumference of a segment sized equal to or smaller than an exterior circumfrence of said nozzle.

4. The applicator apparatus of claim 3 additionally comprsing:
perforations in a wall of said axial conduit running normal to an axis of said interior circumference in positions rendering said segments removable from said elastic conduit.

5. The applicator apparatus of claim 1 additionally comprising
a plurality of said applicators in a kit of said applicators; and
mating fasteners for removable engagement of said first side of each of said pluarity of applicators to said second end of said enagement component, whereby any of said plurality of applicators is removably engageable with said engagement component.

6. The applicator apparatus of claim 2 additionally comprising
a plurality of said applicators in a kit of said applicators; and
mating fasteners for removable engagement of said first side of each of said pluarity of applicators to said second end of said enagement component, whereby any of said plurality of applicators is removably engageable with said engagement component.

7. The applicator apparatus of claim 3 additionally comprising
a plurality of said applicators in a kit of said applicators; and
mating fasteners for removable engagement of said first side of each of said plurality of applicators to said second end of said engagement component, whereby any of said plurality of applicators is removably engageable with said engagement component.

8. The applicator appratus of claim 4 additionally comprising
a plurality of said applicators in a kit of said applicators; and
mating fasteners for removable engagement of said first side of each of said plurality of applicators to said second end of said engagement component, whereby any of said plurality of applicators is removably engageable with said engagement component.

9. The applicator apparatus of claim 1 wherein, said means for removable enagement of said first end to a nozzle of a spray bottle, comprises:
a nozzle body having a threaded aperture sized for threaded engagement with a bottle;
a tube communicating through said threaded aperture between a lower end of said bottle, and a handle opperated pump in said nozzle body; and
said nozzle in sealed communication with said engagement component at one end and to an outlet of said pump at an opposite end.

10. The applicator apparatus of claim 9 additionally comprising:
a plurality of said applicators in a kit of said applicators; and
mating fasteners for removable engagement of said first side of each of said plurality of applicators to said second end of said engagement component, whereby any of said plurality of applicators is removably engageable with said engagement component.
